(19) United States
(12) Patent Application Publication
(10) Pub. No.: US 2008/0279164 A1
(43) Pub. Date: Nov. 13, 2008

(54) METHOD FOR CONNECTING TO A WIRELESS NETWORK

(76) Inventors: JEN-CHIH WU, Taoyuan (TW); SHENG-FU CHENG, Taipei (TW); JUNG-JEN LEE, Banciao City (TW); NAI-WEN HUANG, Bade City (TW); SHIH-WU FAN-JIANG, Pingjhen City (TW); YEN-CHUN LIAO, Taichung City (TW)

Correspondence Address: RABIN & Berdo, PC, 1101 14TH STREET, NW, SUITE 500, WASHINGTON, DC, 20005, US

(21) Appl. No.: 12/045,980

(22) Filed: Mar. 11, 2008

(30) Foreign Application Priority Data
May 7, 2007 (TW) 096116047

(51) Int. Cl. H04Q 7/24

(52) U.S. Cl. 370/338

(57) ABSTRACT

The present invention provides a method for connecting with a wireless network device. The method includes following steps: upon configuring the wireless network device, executing a first target procedure to connect the wireless network device with the terminal device; executing a second target procedure, allowing the sharing device to be searched by the wireless network device according to at least one target signal; executing a third target procedure to select a target sharing device corresponding to the wireless network device according to the target signal; and connecting wirelessly the wireless network device with the target sharing device.

### BACKGROUND OF THE INVENTION

a) Field of the Invention

The present invention relates to a method for installing a wireless network device, and more particularly to a method that automatically install a wireless network device.

b) Description of the Prior Art

A network camera is used more and more popularly, and is gradually entering into daily life, such that more and more users are using the network cameras. Moreover, following the development of a wireless network, a network camera that is equipped with a wireless network function begins to show up in the 3C market. However, the first step for a user to use a wireless network camera is to install the wireless network camera, such that the network camera can access connection with a wireless network access point, and is in turn connected to Internet or a local area network through the wireless network access point. In terms of the installation of the wireless network camera, typical hardware architecture is that the wireless network camera is coupled to the wireless network access point through the Ethernet, and the wireless network access point is coupled to a personal computer with the Ethernet. For a conventional installation procedure, the personal computer should access connection with the corresponding wireless network access point first, and then, the user will use the personal computer to access the setup webpage of the wireless network access point to obtain related parameters of that wireless network access point. Next, the personal computer should access connection with the wireless network camera, and then, the user should use the personal computer to access the setup webpage of the wireless network camera and fill in the parameters in the corresponding field.

Accordingly, when the user installs the wireless network camera, he should first know how to access the setup web pages of the wireless network access point and the wireless network camera. In addition, the user should have a fair amount of understanding and knowledge to the related parameters of the wireless network access point, including SSID, a condition of data encryption, a code encryption method (WEP, WPA1, WPA) etc. so that he could fill in the parameters correctly. For the ordinary user who is not equipped with background knowledge of networking, the aforementioned installation procedure is rather complicated and is provided with a considerable difficulty.

On the other hand, in the conventional installation procedure, once the user has obtained the related parameters of the wireless network access point and configured the related parameters into the wireless network camera, he will not be able to know at once whether the wireless network camera has been correctly connected with the wireless network access point. In other words, the user should usually take following steps to make a confirmation:
(1) manually cutting off the wired connection between the personal computer and the wireless network camera by, for example, pulling out an Ethernet line between the wireless network access point and the wireless network camera; and
(2) trying to connecting with the wireless network camera through Internet to confirm whether the installation has succeeded.

As the aforementioned installation procedure should be accomplished with considerable networking knowledge, the ordinary user will often not be able to configure the wireless network camera correctly by oneself. Furthermore, as the aforementioned installation procedure is rather complicated, it will increase a lot of burdens even for a professional user.

### SUMMARY OF THE INVENTION

Accordingly, the primary object of the present invention is to provide a method for connecting with a wireless network device. In the present invention, an automatic installation procedure is provided, wherein a computer program is used to obtain by itself related parameters of a wireless network access point, and accomplish a setup procedure through a wireless network function of the wireless network device, without requiring a user to proceed with a complicated installation work.

Accordingly, the present invention discloses a method for connecting with a wireless network device, which is applied to a wireless network and includes following steps: a first target procedure is executed to connect the wireless network device with the terminal device; next, a second target procedure is executed so that at least one sharing device is searched by the wireless network device according to at least one target signal; following that, a third target procedure is executed to connect the wireless network device wirelessly with the target sharing device, according to the aforementioned target signal.

Accordingly, under an initial state, the first target procedure, the second target procedure and the third target procedure are used to install the wireless network device.

Accordingly, if the user executes the first target procedure, the second target procedure and the third target procedure again, then the original target sharing device can be replaced with a new target sharing device.

Accordingly, the aforementioned wireless network device is a wireless network camera.

Accordingly, the aforementioned sharing device is a wireless network access point.

Accordingly, the aforementioned terminal device is a personal computer.

Accordingly, the aforementioned first target procedure connects the wireless network device in wires with the terminal device through the Ethernet or USB.

Accordingly, the aforementioned first target procedure connects the wireless network device wirelessly with the terminal device through wireless transmission, Bluetooth transmission, or infrared transmission.

Accordingly, the aforementioned second target procedure includes the searching for the sharing device by the wireless network device; the reception of the target signal by the wireless network device; the interpretation of the target signal by the wireless network device to obtain the plural target parameters; and the transmission of these target parameters to the terminal device by the wireless network device.

Accordingly, the aforementioned target parameters include an SSID, a signal intensity parameter, and an encryption identification parameter.

Accordingly, the aforementioned third target procedure includes the identification of at least one sharing device by the terminal device, according to the plural target parameters; displaying the at least one corresponding sharing device on the display device by the terminal device, to allow the user to select one target sharing device; the user selecting any one sharing device as the target sharing device; the terminal device determining whether this target sharing device uses an encryption function; the terminal device transmitting the connection instruction to the wireless network device, provided that the target sharing device does not use the encryption function; the wireless network device being connected wirelessly with the target sharing device by the connection instruction; requesting the user to input the secret key, provided that the target sharing device uses the encryption function; the terminal device transmitting the connection instruction and the secret key to the wireless network device; and the wireless network device being connected wirelessly with the target sharing device by the connection instruction and the secret key.

Accordingly, the aforementioned method further includes the test procedure, which comprises the following steps: the wireless network device detecting whether the sharing device has been connected wirelessly; the wireless network device confirming the connection state, provided that the sharing device has been connected wirelessly with the wireless network device; the terminal device transmitting a confirmation message to the wireless network device through the target sharing device; the wireless network device determining whether in the default time period the confirmation message is received; the message of connection success being transmitted to the terminal device, provided that in the default time period the wireless network device has received this confirmation message; the wireless network device transmitting the message of connection timeout to the terminal device, provided that in the default time period the wireless network device has not received this confirmation message.

Accordingly, the aforementioned method further includes the following steps: after accomplishing the first target procedure, the second target procedure and the third target procedure, the terminal device displaying the instruction message to inform the user to separate the wireless network device from the terminal device, provided that the connection succeeds.

Accordingly, the present invention omits the complicated setup procedure of the prior art, and automatically execute the setup work. For the ordinary user who does not possess the networking background knowledge, the installation procedure is implemented very easily, allowing the user to easily install the wireless network camera. Moreover, for the professional user, the present invention can also largely reduce his burdens. Therefore, the present invention overcomes the shortcomings of the prior art, enables the wireless network camera to be popularized, and allows general public to enjoy the convenience that is brought by the wireless network camera.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a preferred embodiment of the present invention.

FIG. 2 shows a schematic view of another preferred embodiment of the present invention.

FIG. 3 shows a flow diagram of a method for connecting with a wireless network device of the present invention.

FIG. 4 shows a flow diagram of a second target procedure of the present invention.

FIG. 5 shows a flow diagram of a third target procedure of the present invention.

FIG. 6 shows a flow diagram of a test procedure of the present invention.

### DETAILED DESCRIPTION OF THE PREFERRED EMBODIMENTS

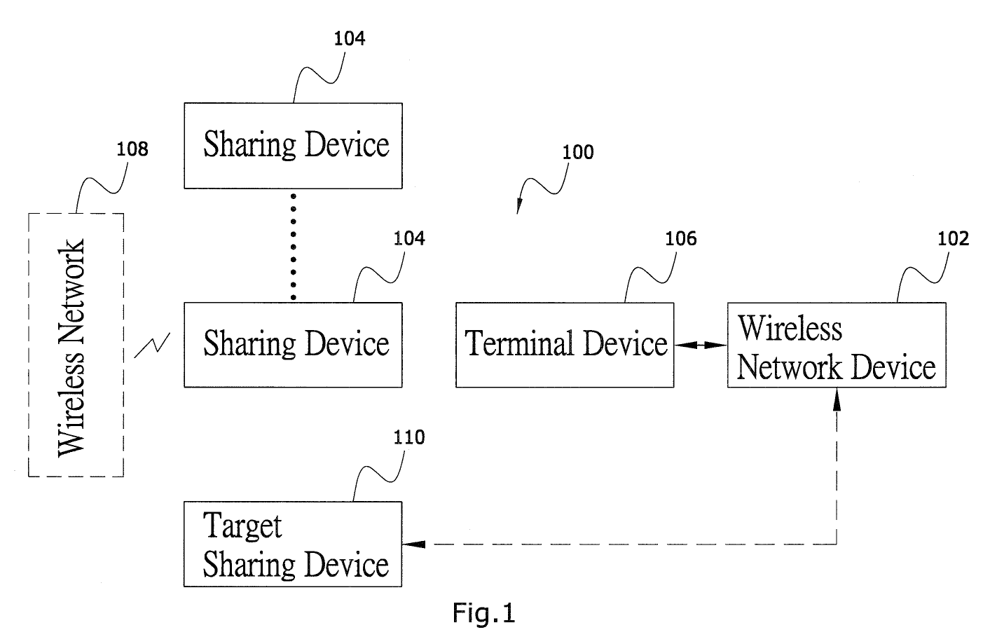

Referring to FIG. 1, it shows a schematic view of a preferred embodiment of the present invention, wherein one of typical architectures for connecting with a wireless network device 100 comprises a wireless network device 102, a plurality of sharing devices 104, a target sharing device 110, a terminal device 106 and a wireless network 108. In this embodiment, the so-called wireless network device 102 is a network camera equipped with a wireless network function, the sharing devices 104 and the target sharing device 110 are wireless network access points, and the terminal device 106 is a personal computer. First, the user will execute a first target procedure to connect the wireless network device 102 with the terminal device 106. In this embodiment, the terminal device 106 is directly connected with the wireless network device 102 with the Ethernet. Following that, the wireless network device 102 will execute a second target procedure. As the plural sharing devices 104 will continuously send out corresponding target signals, these sharing devices 104 can be searched by the wireless network device 102, through receiving these target signals. Following that, the wireless network device 102 and the terminal device 106 will execute a third target procedure. According to these target signals, the user will select one of the sharing devices 104 as the target sharing device 110. As corresponding target parameters are accessed by the wireless network device 102, the wireless network device 102 can carry out wireless connection with the target sharing device 110.

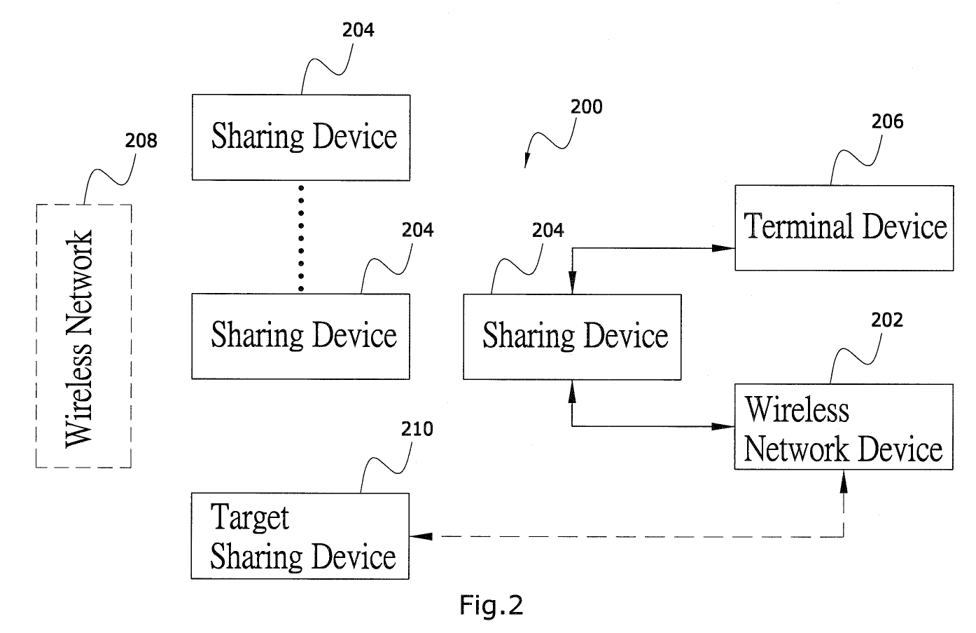

Referring to FIG. 2, it shows a schematic view of another preferred embodiment of the present invention, wherein one of typical architectures for connecting with a wireless network device 200 comprises a wireless network device 202, a plurality of sharing devices 204, a target sharing device 210, a terminal device 206 and a wireless network 208. The difference of this embodiment with that in FIG. 1 lies in that in the first target procedure, the terminal device 206 is coupled to the sharing device 204 by the Ethernet, and the wireless network device 202 is coupled to the same sharing device 204 by the Ethernet, which in turn connects the terminal device 206 with the wireless network device 202 through the sharing device 204. It is worthy of mention that the sharing device 204, which acts as a connection medium between the terminal device 206 and the wireless network device 202 can be a wireless network access point, or a router, a switch, or a hub.

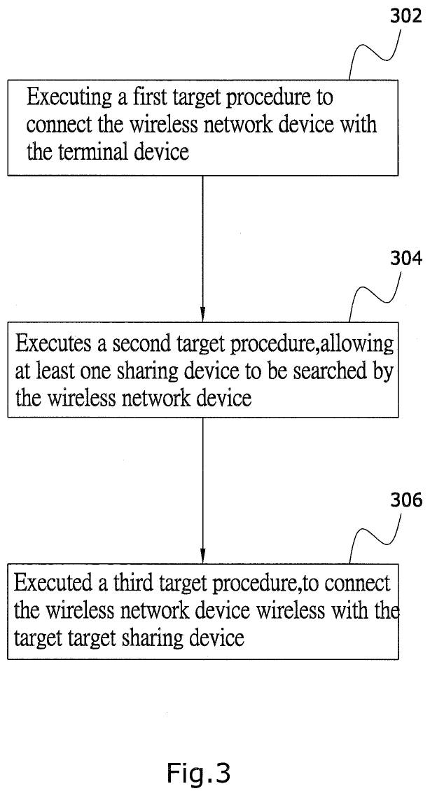

Referring to FIG. 3, it shows a flow diagram of a method for connecting with a wireless network device of the present invention. As shown in the drawing, the method includes following steps:
(1) The user executes a first target procedure to connect the wireless network device with the terminal device (302);
(2) According to at least one target signal, the wireless network device executes a second target procedure, allowing at least one sharing device to be searched by the wireless network device (304);
(3) By that target signal, a third target procedure is executed to connect the wireless network device wirelessly with the target sharing device (306).

Under an initial state, the first target procedure, the second target procedure and the third target procedure are an installation program, which is used to install the wireless network device. Moreover, by a wired communication method, such as the Ethernet or Universal Serial Bus (USB), the first target procedure can use the wired communication method to connect the wireless network device with the terminal device. On the other hand, by a wireless communication method, such as wireless transmission, Bluetooth transmission, or infrared transmission, the first target procedure can use the wireless communication method to connect the wireless network device with the terminal device. The target signal is a beacon packet, and the sharing device continuously sends out the beacon packet.

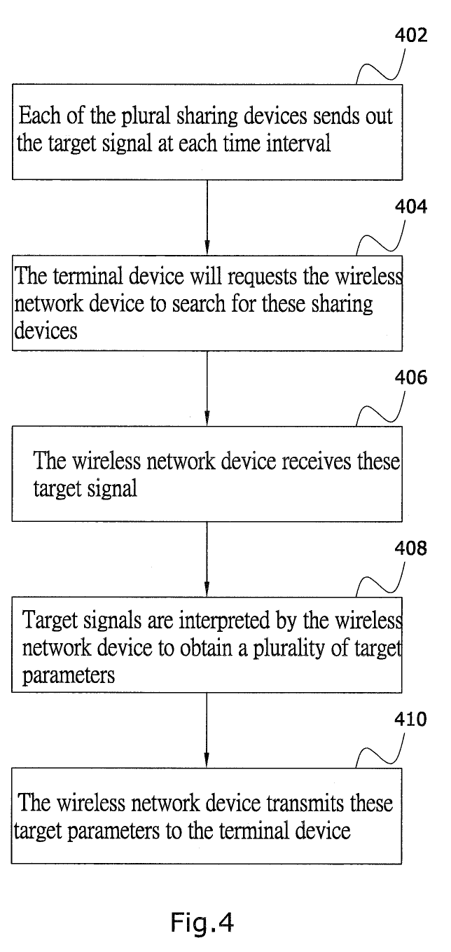

Referring to FIG. 4, it shows a flow diagram of a second target procedure of the present invention, which includes following steps:
(1) Each of the plural sharing devices sends out the target signal at each time interval (402). Next, the terminal device will request the wireless network device to search for these sharing devices (404);
(2) The wireless network device receives these target signals (406);
(3) These target signals are interpreted by the wireless network device to obtain a plurality of target parameters (408);
(4) The wireless network device transmits these target parameters to the terminal device (410).

The aforementioned target parameters include the Service Set Identifier (SSID), a signal intensity parameter, and an encryption identification parameter, and etc. The encryption identification parameter is used to identify whether the corresponding sharing device is provided with an encryption function.

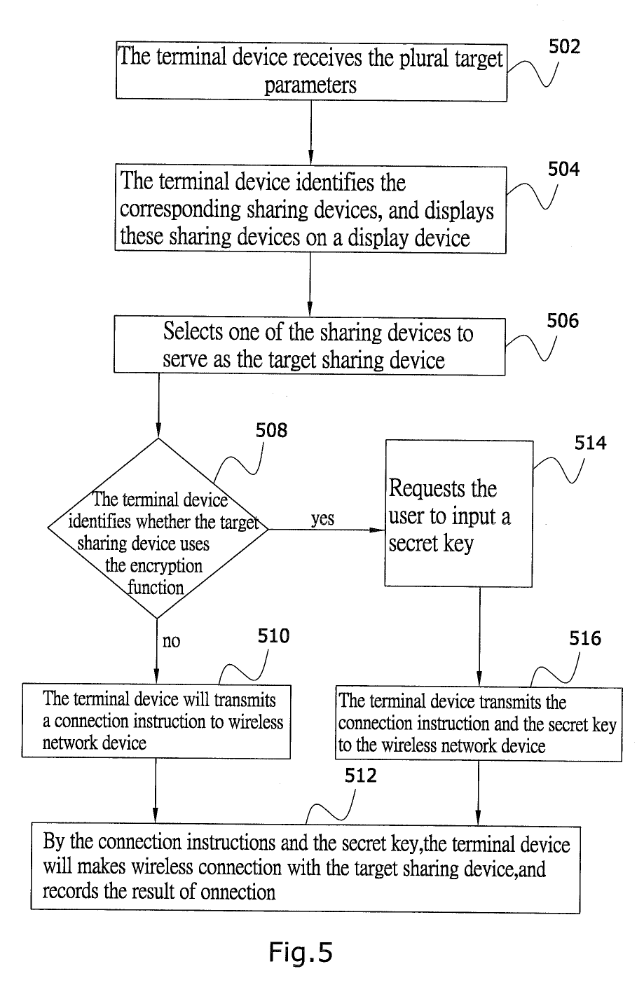

Referring to FIG. 5, it shows a flow diagram of a third target procedure of the present invention, which includes following steps:
(1) The terminal device receives the plural target parameters (502);
(2) According to these target parameters, the terminal device identifies the corresponding sharing devices, and display these sharing devices on a display device (not shown in the drawing)(504);
(3) The user selects one of the sharing devices to serve as the target sharing device (506);
(4) The terminal device identifies whether the target sharing device uses the encryption function (508);
(5) If the target sharing device does not use that encryption function, then the terminal device will transmit a connection instruction to the wireless network device (510);
(6) By that connection instruction, the wireless network device will make wireless connection with the target sharing device, and record a result of connection (512). If the target sharing device uses the encryption function, then the third target procedure will request the user to input a secret key (514);
(7) The terminal device transmits the connection instruction and the aforementioned secret key to the wireless network device (516);
(8) By the connection instruction and the aforementioned secret key, the terminal device will make wireless connection with the target sharing device, and record the result of connection (512).

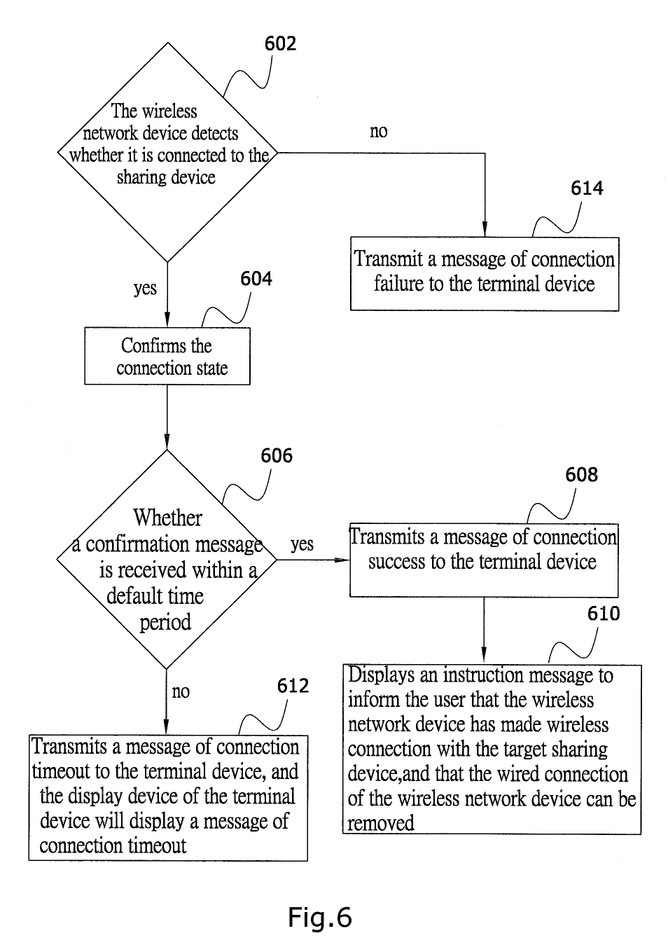

Referring to FIG. 6, it shows a flow diagram of a test procedure of the present invention, including following steps:
(1) The wireless network device detects whether it is connected to the sharing device (602). If the wireless network device has detected that the sharing device has been connected wirelessly, then the wireless network device will confirm the connection state (604);
(2) Next, if a connection record of the sharing device of the wireless network device indicates that the connection has been established, then the wireless network device will determine whether a confirmation message is received within a default time period (606).
(3) If in the default time period, the wireless network device receives the confirmation message, then the wireless network device will transmit a message of connection success to the terminal device (608);
(4) The display device (not shown in the drawing) of the terminal device displays an instruction message to inform the user that the wireless network device has made wireless connection with the target sharing device, and that the wired connection of the wireless network device can be removed (610);
(5) If in the default time period, the wireless network device does not receive the confirmation message, then the wireless network device will transmit a message of connection timeout to the terminal device, and the display device of the terminal device will display a message of connection timeout (612);
(6) If the wireless network device has detected that the sharing device has not been connected wirelessly, then the wireless network device will transmit a message of connection failure to the terminal device (614).

It is worthy of mention that in the test procedure, the confirmation message issued by the terminal device is transmitted wirelessly to the wireless network device through the target sharing device. Moreover, the message of connection timeout usually indicates that the sharing device to be connected by the wireless network device is not the target sharing device that the user selects. Another implementation of the test procedure is that the confirmation message can be issued by the wireless network device through the target sharing device, and it is the terminal device to determine if the confirmation message has been received in the default time period. Furthermore, if the user is to replace the target sharing device, then he can execute the first target procedure, the second target procedure, the third target procedure and the test procedure again, to re-select another target sharing device and to accomplish the testing.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method for connecting with a wireless network device, which is applied to a wireless network, comprising:
executing a first target procedure, to connect a wireless network device with a terminal device;
executing a second target procedure, enabling at least one sharing device to be searched by the wireless network device according to at least one target signal; and
executing a third target procedure, to connect the wireless network device wirelessly with a target sharing device by the target signal.

2. The method for connecting with a wireless network device, according to claim 2, wherein the first target procedure, the second target procedure and the third target procedure are used to install the wireless network device under an initial state.

3. The method for connecting with a wireless network device, according to claim 2, wherein if the sharing device is to be replaced, then the first target procedure, the second target procedure and the third target procedure are executed once more.

4. The method for connecting with a wireless network device, according to claim 1, wherein the wireless network device is one of a network camera or an audiovisual server, equipped with a wireless network function.

5. The method for connecting with a wireless network device, according to claim 1, wherein the sharing device is a wireless network access point.

6. The method for connecting with a wireless network device, according to claim 1, wherein the terminal device is a personal computer.

7. The method for connecting with a wireless network device, according to claim 1, wherein the first target procedure includes connecting the wireless network device with the terminal device by a wired transmission method.

8. The method for connecting with a wireless network device, according to claim 1, wherein the first target procedure includes connecting the wireless network device with the terminal device by a wireless transmission method.

9. The method for connecting with a wireless network device, according to claim 1, wherein the second target procedure includes the sharing device sending out the target signal continuously; searching for the sharing device; receiving the target signal; interpreting the target signal to obtain a plurality of target parameters; and transmitting the target parameters to the terminal device.

10. The method for connecting with a wireless network device, according to claim 1, wherein the third target procedure includes: identifying these sharing devices according to the plural target parameters;
selecting one of the sharing devices as the target sharing device;
determining whether the target sharing device uses an encryption function;
transmitting a connection instruction to the wireless network device, provided that the target sharing device does not use the encryption function; and
connecting the wireless network device wirelessly with the target sharing device by the connection instruction.

11. The method for connecting with a wireless network device, according to claim 1, wherein the third target procedure includes:
identifying these sharing devices according to the plural target parameters;
selecting one of the sharing devices as the target sharing device; determining whether the target sharing device uses an encryption function;
requesting to input a secret key, provided that the target sharing device uses the encryption function;
transmitting a connection instruction and the secret key to the wireless network device; and
connecting the wireless network device wirelessly with the target sharing device by the connection instruction and the secret key.

12. The method for connecting with a wireless network device, according to claim 1, wherein the third target procedure further includes after the terminal device receives the plural target parameters, the terminal device displaying the corresponding sharing device on a display device, to select the target sharing device.

13. The method for connecting with a wireless network device, according to claim 1, wherein the method further includes a test procedure which comprises following steps:
detecting whether the wireless network device has been connected wirelessly with the sharing device;
confirming a connection state, provided that the wireless network device has been connected wirelessly with the sharing device;
determining in a default time period whether the wireless network device has received a confirmation message; and
if in the default time period, the wireless network device has received the confirmation message, then transmitting a message of connection success to the terminal device.

14. The method for connecting with a wireless network device, according to claim 13, wherein said terminal device transmits wirelessly the confirmation message to the wireless network device through the target sharing device.

15. The method for connecting with a wireless network device, according to claim 1, wherein the method further includes a test procedure which comprises following steps:
detecting whether the wireless network device has been connected wirelessly with the sharing device;
confirming a connection state, provided that the wireless network device has been connected wirelessly with the sharing device;
determining in a default time period whether the terminal device has received a confirmation message; and
if in the default time period, the terminal device has received the confirmation message, then displaying a message of connection success.

16. The method for connecting with a wireless network device, according to claim 15, wherein the wireless network device transmits wirelessly the confirmation message to the terminal device through the target sharing device.

17. The method for connecting with a wireless network device, according to claim 1, wherein the method further includes a test procedure, which comprises following steps:
detecting whether the wireless network device has been connected wirelessly with the sharing device; and
if the wireless network device has not been connected wirelessly with the sharing device, then transmitting a message of connection failure to the terminal device.

18. The method for connecting with a wireless network device, according to claim 1, wherein the method further includes a test procedure, which comprises following steps:
detecting whether the wireless network device has been connected wirelessly with the sharing device;
confirming a connection state, provided that the wireless network device has been connected wirelessly with the sharing device;
determining in a default time whether the wireless network device has received a confirmation message; and
if in the default time period, the wireless network device has not received the confirmation message, then transmitting a message of connection timeout to the terminal device.

19. The method for connecting with a wireless network device, according to claim 18, wherein the terminal device transmits wirelessly the confirmation message to the wireless network device through the target sharing device.

20. The method for connecting with a wireless network device, according to claim 1, wherein the method further includes a test procedure, which comprises following steps:
detecting whether the wireless network device has been connected wirelessly with the sharing device;
confirming a connection state, provided that the wireless network device has been connected wirelessly with the sharing device;
determining in a default time period whether the terminal device has received a confirmation message; and
if in the default time period, the terminal device has not received the confirmation message, then displaying a message of connection timeout.

21. The method for connecting with a wireless network device, according to claim 20, wherein the wireless network device transmits wirelessly the confirmation message to the terminal device through the target sharing device.

22. The method for connecting with a wireless network device, according to claim 1, wherein the method further includes following steps:
after executing the first target procedure, the second target procedure and the third target procedure, if the terminal device has received a message of connection success, then the terminal device displaying an instruction message to inform a user that the wireless network device has been connected wirelessly with the target sharing device, so as to remove wired connection of the wireless network device.
